(19) United States
(12) Patent Application Publication
(10) Pub. No.: US 2024/0220395 A1
(43) Pub. Date: Jul. 4, 2024

(54) APPARATUS AND METHOD FOR GENERATING DEBUG INFORMATION

(71) Applicant: Arm Limited, Camebridge (GB)

(72) Inventors: Parameshwarappa Anand Kumar Savanth, Cambridge (GB); Sahan Sajeewa Hiniduma Udugama Gamage, Cambridge (GB); Wei Wang, Cambridge (GB); Andreas Lars Sandberg, Cambridge (GB)

(73) Assignee: Arm Limited, Cambridge (GB)

(21) Appl. No.: 18/554,773

(22) PCT Filed: Feb. 10, 2022
(86) PCT No.: PCT/GB2022/050365

§ 371 Date: Oct. 10, 2023

(30) Foreign Application Priority Data
Apr. 13, 2021 (GB) 2105240.2

(51) Int. Cl. G06F 11/36

(52) U.S. Cl. CPC G06F 11/3636; G06F 11/3656

(57) ABSTRACT

An apparatus and method are described for generating debug information. The apparatus has processing circuitry for executing a sequence of instructions that includes a plurality of debug information triggering instructions, and debug information generating circuitry for coupling to a debug port. On executing a given debug information triggering instruction, the processing circuitry is arranged to trigger the debug information generating circuitry to generate a debug information signal whose form is dependent on a control parameter specified by the given debug information triggering instruction. The generated debug information signal is output from the debug port for reference by a debugger. The control parameter is such that the form of the debug information signal enables the debugger to determine a state of the processing circuitry when the given debug information triggering instruction was executed.

### BACKGROUND

The present technique relates to an apparatus and method for generating debug information.

Traditional debug techniques can give rise to significant cost and complexity within a data processing system, both in terms of the silicon area cost and/or pin count associated with such debug functionality, and the energy consumption associated with such debug techniques. In some systems, for example in those employing small, low power, devices, the cost and complexity associated with providing debug support can be problematic.

Also, existing debug techniques can give rise to reliability issues in certain situations. By way of specific example, in recent years there has been increased interest in devices that do not have a dedicated power supply, but instead incorporate energy harvesting techniques in order to derive the power required to perform their operations. However, in such implementations the availability of power may ebb and flow, and the device may need to tailor the performance of its tasks to periods of time when power is available. Existing debug techniques often fail in such scenarios where power is intermittent. For example, the debugger may hang when a processing device being debugged powers down arbitrarily (for example to spoof the intermittency of available power that may occur when the device is deployed), and this can cause a loss of useful debug information. Existing debug techniques are typically geared to handling exceptions and processor lockup in situations where the debugger and processing device can remain powered. It would accordingly be desirable to provide an improved mechanism for generating debug information.

### SUMMARY

In one example arrangement, there is provided an apparatus comprising: processing circuitry to execute a sequence of instructions that includes a plurality of debug information triggering instructions; and debug information generating circuitry for coupling to a debug port; wherein: the processing circuitry is arranged, on executing a given debug information triggering instruction in the plurality of debug information triggering instructions, to trigger the debug information generating circuitry to generate a debug information signal whose form is dependent on a control parameter specified by the given debug information triggering instruction, and to output the generated debug information signal from the debug port for reference by a debugger apparatus; and the control parameter is such that the form of the debug information signal enables the debugger apparatus to determine a state of the processing circuitry when the given debug information triggering instruction was executed.

In another example arrangement, there is provided a method of generating debug information, comprising: executing within processing circuitry a sequence of instructions that includes a plurality of debug information triggering instructions; coupling debug information generating circuitry to a debug port; on executing within the processing circuitry a given debug information triggering instruction in the plurality of debug information triggering instructions, triggering the debug information generating circuitry to generate a debug information signal whose form is dependent on a control parameter specified by the given debug information triggering instruction; and outputting the generated debug information signal from the debug port for reference by a debugger apparatus; wherein the control parameter is such that the form of the debug information signal enables the debugger apparatus to determine a state of the processing circuitry when the given debug information triggering instruction was executed.

In a still further example arrangement, there is provided a computer program for controlling a host data processing apparatus to provide an instruction execution environment, comprising: processing program logic to execute a sequence of instructions that includes a plurality of debug information triggering instructions; and debug information generating program logic for coupling to a debug port; wherein: the processing program logic is arranged, on executing a given debug information triggering instruction in the plurality of debug information triggering instructions, to trigger the debug information generating program logic to generate a debug information signal whose form is dependent on a control parameter specified by the given debug information triggering instruction, and to output the generated debug information signal from the debug port for reference by a debugger apparatus; and the control parameter is such that the form of the debug information signal enables the debugger apparatus to determine a state of the processing program logic when the given debug information triggering instruction was executed.

### BRIEF DESCRIPTION OF THE DRAWINGS

The present technique will be described further, by way of illustration only, with reference to examples thereof as illustrated in the accompanying drawings, in which:

FIG. 1 is a diagram schematically illustrating the intermittent compute activities of a battery-less processing device;

FIG. 2 is a block diagram illustrating an apparatus in accordance with one example implementation;

FIGS. 3A to 3C illustrate a number of different formats of a debug information triggering instruction in accordance with example implementations;

FIG. 4 schematically illustrates the use of debug information triggering instructions in accordance with one example implementation;

FIG. 5 schematically illustrates the use of debug information triggering instructions to detect branch behaviour in accordance with one example implementation;

FIG. 6 schematically illustrates various different example forms of debug information signal that may be used;

FIG. 7 illustrates debug information signals that may be generated in one specific example;

FIG. 8 is a flow diagram illustrating the use of debug information triggering instructions in accordance with one example implementation;

FIG. 9 is a flow diagram illustrating how the behaviour in response to debug information trigger instructions may be made dependent upon the presence or absence of an enable signal in accordance with one example implementation;

FIG. 10 illustrates one example form of debug information triggering instruction;

FIG. 11 illustrates how an intermediate entity may be used to transform the debug information signals generated in response to execution of debug information triggering instructions into other information that can then be passed to a debugger;

FIG. 12 is a flow diagram illustrating steps taken in response to a calibration trigger in accordance with one example implementation; and

FIG. 13 illustrates a simulator implementation that can be used.

### DESCRIPTION OF EXAMPLES

In one example implementation an apparatus is provided that has processing circuitry for executing a sequence of instructions, where that sequence of instructions includes a plurality of debug information triggering instructions. The apparatus also provides debug information generating circuitry that can be coupled to a debug port in order to enable communication with a debugger. The processing circuitry may be arranged, on executing a given debug information triggering instruction in the plurality of debug information triggering instructions, to trigger the debug information generating circuitry to generate a debug information signal whose form is dependent on a control parameter specified by the given debug information triggering instruction. The generated debug information signal is then output from the debug port for reference by a debugger apparatus. The control parameter is arranged such that the form of the debug information signal enables the debugger apparatus to determine a state of the processing circuitry when the given debug information triggering instruction was executed.

It has been found that the use of such debug information triggering instructions can provide a low cost and energy efficient mechanism for providing debug information to a debugger apparatus. Such an approach can also alleviate some of the reliability concerns associated with known debugging techniques. Since in accordance with the present technique, execution of a debug information triggering instruction triggers the debug information generating circuitry to generate a debug information signal from a debug port, the area and pin count issues associated with known prior art techniques are alleviated. Furthermore such an approach enables the debug information signal to be generated with low latency. In addition, because the form of the debug information signal generated by the debug information generating circuitry is dependent on the control parameter specified by the given debug information triggering instruction, the control parameter can be specified in a way that enables the form of the debug information signal to indicate the state of the processing circuitry at the time the given debug information triggering instruction was executed. Indeed, in one example implementation, this mechanism enables the debug information signal to provide information that can be used by the debugger apparatus to determine the state of the processing circuitry at the instant/clock cycle when that associated debug information triggering instruction was executed.

Whilst in some implementations the debugger apparatus may be able to derive useful information from the debug information signal generated by a single instance of the debug information triggering instructions, in one example implementation the debugger is arranged to make reference to the debug information signals generated by execution of multiple debug information triggering instructions. In particular, in one example implementation, one or more of the debug information triggering instructions in the plurality of debug information triggering instructions has a control parameter that differs to the control parameter specified by one or more other debug information triggering instructions in the plurality of debug information triggering instructions, such that the form of the debug information signal generated by the debug information generating circuitry is dependent on which debug information triggering instruction is executed. Hence, by such an approach, it is possible for the debugger apparatus to use the various generated debug information signals to keep track of the debug information triggering instructions that have been executed, and based on that information to then infer how far through the sequence of instructions the processing circuitry has reached.

Thus, in one example implementation the debug information generating circuitry is arranged to generate a series of debug information signals in response to a series of debug information triggering instructions in the plurality being executed, to enable the debugger apparatus to determine the state of the processing circuitry when the given debug information triggering instruction was executed based on both the form of the debug information signal generated as a result of executing the given debug information triggering instruction and the form of one or more previously generated debug information signals. Since the debug information signals are generated directly as a result of each debug information triggering instruction being executed by the processing circuitry, and those debug information signals can be generated with low latency from the debug port, this can provide the debugger with essentially real-time information about the progress of execution of the sequence of instructions by the processing circuitry, hence facilitating software debugging.

The state of the processing circuitry that may be derived by the debugger apparatus from the form of the various generated debug information signals can take a variety of forms, dependent upon implementation. For example, from the debug information signals, the debugger apparatus may be able to determine a variety of information about the status of the processing circuitry at the time each corresponding debug information triggering instruction was executed. In one example implementation, the state of the processing circuitry that is determined by the debugger apparatus from the debug information signal may be an indication of which instructions within the sequence of instructions had been executed by the processing circuitry at the time the associated debug information triggering instruction was executed. Hence, by such an approach, the debug information signals can be used to indicate where in the program flow the processing circuitry was at the time a particular debug information signal was generated.

There are a number of ways in which the control parameter can be used by the debug information generating circuitry. In one example implementation, the debug information generating circuitry is arranged to determine a duration of time for which the debug information signal is output from the debug port in dependence on the control parameter specified by the given debug information triggering instruction. It should be noted that this determined duration of time is entirely independent of the time taken by the processing circuitry to execute the associated debug information triggering instruction, and hence the assertion of the debug information signals can be asynchronous to the execution of the associated debug information triggering instructions. In particular, the observable output provided by the debug information signal may persist for a variable number of clock cycles, without affecting the time the associated debug information triggering instruction takes to be executed by the processing circuitry.

In addition to the control parameter being used to determine the duration of time for which the debug information signal is output, the control parameter can also be used to influence other aspects of the debug information signal. For example, the debug information generating circuitry may be arranged to control, in dependence on the control parameter, at least one of a number of pulses, a duration of individual pulses and a time gap between pulses when generating the form of the debug information signal output during the determined duration of time. As another example, the control parameter may also be used to control the state (i.e. the high/low nature) of the debug information signal, and hence, for example, whether the asserted pulses are asserted high pulses or asserted low pulses.

In one example implementation, the determined duration of time is one or more clock cycles, where the number of clock cycles is dependent on the control parameter. However, as noted earlier, in one example implementation, the time taken by the processing circuitry to execute the given debug information triggering instruction may be independent of the determined duration of time over which the associated debug information signal is output from the debug port, thus decoupling the generation of the debug information signal from the time taken to execute the associated debug information triggering instruction within the processing circuitry. This provides the benefit that, whilst the form of the various debug information signals generated may vary dependent upon the control parameter specified by the associated debug information triggering instructions, each debug information triggering instruction may exhibit the same behaviour within the processing circuitry, and hence the behaviour of the processing circuitry is not altered irrespective of the form of debug information signal generated. This can enable the underlying behaviour of the code being debugged to be unaffected by the debug information triggering instructions added to that code.

Given that the number of clock cycles during which a debug information signal may be asserted can vary, then in one example implementation steps may be taken to ensure that there is separation between the debug information signals generated as a result of execution of different debug information triggering instructions. In particular, in one example implementation the debug information triggering instructions are separated from each other within the sequence of instructions by an amount that ensures that at least T clock cycles pass between execution of adjacent debug information triggering instructions. Furthermore, the determined duration of time for each debug information signal is constrained to have a maximum value of W clock cycles, where W is less than T in order to ensure a separation between each debug information signal output from the debug port.

The processing circuitry can be organised in a variety of ways, but in one example implementation comprises a plurality of pipeline stages and is arranged to process each debug information triggering instruction in a manner that prevents the execution of that debug information triggering instruction causing a subsequent instruction in the sequence to stall within one or more pipeline stages of the processing circuitry. This can ensure that the instrumentation of the sequence of instructions with the various debug information triggering instructions does not alter the underlying behaviour of the code, which hence ensures that the mechanism being used to debug the software does not in itself influence the behaviour of the software being debugged.

There are a number of ways in which the execution of the debug information triggering instructions can be arranged to exhibit such behaviour, but in one example implementation each debug information triggering instruction can be viewed as being similar to a no operation (NOP) instruction in terms of its passage through the pipeline stages of the processing circuitry without affecting the timing of other instructions. However, in contrast to a no operation, the execution of the debug information triggering instruction will cause the debug information generating circuitry to be triggered to generate an associated debug information signal.

In one example implementation, the plurality of pipeline stages includes a given pipeline stage where the debug information triggering instruction becomes non-speculative, and each debug information triggering instruction is executed in a single clock cycle within the given pipeline stage. By such a mechanism, this can be used to ensure that execution of the debug information triggering instruction prevents stalling of a subsequent instruction in the instruction sequence. The given pipeline stage can be any suitable pipeline stage, and for example could be an execute stage of the pipeline. Alternatively, the given stage could be a write back stage, or indeed could be the commit stage in an out-of-order pipeline.

The control parameter specified by each debug information triggering instruction can take a variety of forms. For example the control parameter may be specified as an immediate value in one example implementation. Alternatively, the control parameter may be specified within an opcode portion of each debug information triggering instruction, so as to effectively provide multiple different types of debug information triggering instruction. In this case, the different types of debug information triggering instruction may themselves provide an indication of the control parameter, and hence can be used to influence the form of the debug information signal generated in response to each such instruction.

As another example, the control parameter may identify one or more registers, and the debug information generating circuitry may be arranged to reference current values of those one or more registers when determining the form of the debug information signal to be generated. Such an approach can introduce a great deal of flexibility as to the various different forms of debug information signal that may be generated.

As a yet further example, the control parameter may be arranged to cause the debug information generating circuitry to derive the form of the debug information signal by modifying the form of one or more previously issued debug information signals. Hence, by such an approach the form of any particular debug information signal can be influenced by previously issued debug information signals, providing another mechanism for the debugger to keep track of program flow.

When compiling code that includes such debug information triggering instructions, steps can be taken to ensure that instructions appearing in program order after a particular instance of a debug information triggering instruction cannot be reordered by the apparatus so as to be executed before that debug information triggering instruction, so as to allow a debugger to track progress through the code based on the observed debug information signals.

In one example implementation, the functionality associated with such debug information triggering instructions can be selectively enabled and disabled. For example, the apparatus may be provided with an input to receive an enable signal, and the debug information generating circuitry may be arranged to inhibit generation of the debug information signal in the absence of the enable signal being asserted. This can be achieved in a variety of ways. For example, the debug information generating circuitry may be arranged to act directly in dependence on the enable signal, or alternatively the trigger from the processing circuitry may be suppressed if the enable signal is not asserted. In that latter event the debug information generating circuitry does not receive a trigger from the processing circuitry, and accordingly does not generate the debug information signals.

There are a number of ways in which debug information triggering instructions can be handled in the absence of such an enable signal. For example, in one implementation the processing circuitry may be arranged to handle the given debug information triggering instruction as a no operation instruction in the absence of the enable signal being asserted. This may be useful in a variety of scenarios. For example, if the apparatus is connected to conventional known debug circuitry, then it may be decided in some instances to employ such known debug mechanisms and hence disable the debug activities provided by the use of the debug information triggering instructions. In the above implementation this can be simply achieved by de-asserting the enable signal.

As another example, rather than treating the given debug information triggering instructions as no operations, the processing circuitry may be arranged, in the absence of the enable signal being asserted, to treat the given debug information triggering instruction as a different type of instruction requiring an alternative operation. Such an approach could for example enable the apparatus to make use of an existing output signal path for use when generating the debug information signals, but with the output path being used for its traditional purpose when the enable signal is de-asserted. As a particular example, the apparatus may support the use of a Send Event (SEV) instruction which can cause an event to be signalled via an output signal path to multiple processor cores within a multi-processor system. Such a mechanism can be used within a multi-processor system as part of a handshake mechanism when a processor wishes to be granted access to a shared resource, and hence for example can be used to implement lock-based access to such a shared resource. If desired, then the debug information signals generated when executing debug information triggering instructions can be issued over the same output path, avoiding the need for any additional pin count. In one particular example implementation, the debug information triggering instructions may be executed in the earlier-described manner when the enable signal is asserted, but when the enable signal is not asserted such debug information triggering instructions can instead be interpreted as SEV instructions.

The above techniques can be used in a wide variety of different implementations. In one particular example the apparatus is arranged to receive power from an energy harvesting source, and further comprises a controller to save state of the apparatus to non-volatile memory, and restore state from the non-volatile memory, in dependence on an energy state of the energy harvesting source. In such a deployment, traditional debug mechanisms can prove unreliable, and the debugging mechanism described herein can provide significant benefits.

In one example implementation, the debug information generating circuitry can be arranged, in response to a calibration trigger, to output a sequence known to the debugger apparatus, for use by the debugger apparatus to calibrate for noise on a communication channel between the debug port and the debugger apparatus. Any mutually known sequence can be used for this purpose. However, in one example implementation, a known random number sequence can be used, which can additionally give the receiver, in this case the debugger, the ability to perform an alignment/synchronisation process. By way of specific example, if the debug information generating circuitry periodically outputs 8 bits at a time of a known random sequence, this will give the debugger apparatus the ability to monitor the progress of computations under noisy conditions, and even complete loss of packets, due to better correlation properties, in mission mode. There are various example scenarios where there may be noise on the communication channel between the debug port and the debugger apparatus, and hence where such techniques could be useful. As a particular example, such an approach may assist in mission mode debugging over the air.

Particular examples will now be described with reference to the Figures.

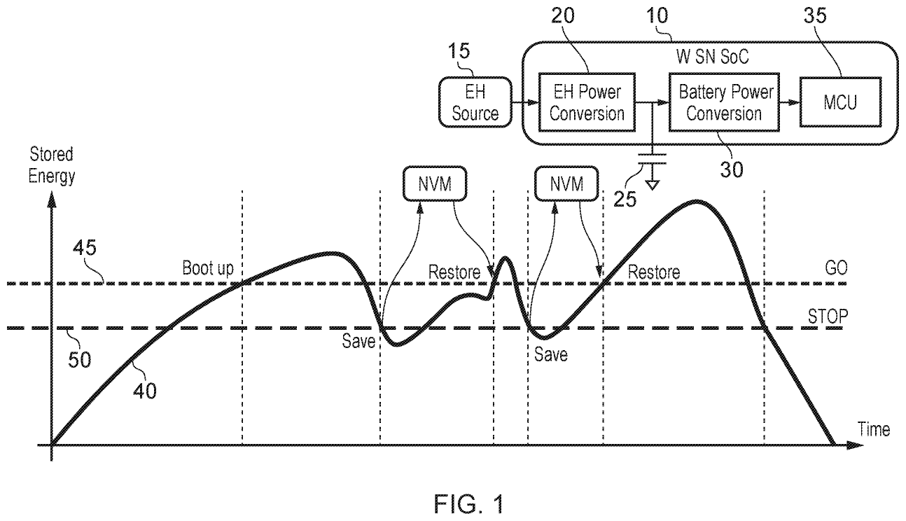

As discussed earlier, the techniques described herein can be used in a wide variety of different scenarios, in order to provide an energy efficient debug mechanism with a low silicon area cost and low pin count requirements. The described approach is also more reliable than known prior art debug techniques when used in scenarios where the power supply to the apparatus may be intermittent. A particular example use case is illustrated in FIG. 1, for a System-on-Chip (SoC) 10 that operates as a battery-less device, and instead obtains its power from energy harvesting. In this example, it is assumed that the SoC 10 is a low powered device including a micro-controller (MCU) 35 that can be arranged to execute a sequence of instructions. As shown in FIG. 1 the SoC 10 can be connected to an energy harvesting source 15, which can take any suitable form in order to extract energy from the surrounding environment, for example to exploit energy sources such as solar power, mechanical vibration, temperature variation, magnetic fields, received radio frequency (RF) signals, etc. The SoC 10 includes an energy harvesting power conversion circuitry 20 for converting the energy received from the source 15 into electrical energy for use by the MCU, with that energy being stored in a suitable form for use by the SoC, in the example of FIG. 1 this being achieved by storing the energy within a capacitive element 25. A battery power conversion circuit 30 can then use the stored energy to provide a power supply to the MCU 35.

Due to the intermittent nature of the available power, then in order to guarantee computational progress it may often be considered necessary to execute the code in multiple chunks depending upon power availability. This is illustrated schematically by the graph in FIG. 1. In particular, the line 40 illustrates the stored energy that may be available within the SoC 10. When the stored energy exceeds a certain boot up threshold 45 (also referred to as a “go” threshold), then the MCU 35 can boot up and begin performing computational work. Conversely, if the stored energy drops below a save threshold 50 (also referred to as a “stop” threshold), then it may be considered appropriate to halt the computational operations performed by the processor 35, at which point a snapshot of the current state of the processor can be saved to non-volatile memory (NVM). By saving such a snapshot when the stored energy drops to the save threshold 50, this allows the processor to quickly have its state restored from the NVM when the energy threshold in due course increases to the boot up threshold 45. This hence prevents restarting code execution from the beginning each time sufficient power is available for the processor to make forward progress, and can therefore enable computational progress to be achieved in the presence of an intermittent power supply.

Existing debug techniques often fail in such an environment where the power is intermittent. For example, the debugger may hang when the processor powers down, causing a loss of useful debug information collected up to the point of the crash. Existing debug mechanisms are typically arranged to handle exceptions and processor lockup in situations where the debugger and the processor can remain powered. As discussed herein, an improved mechanism for generating debug information is provided that alleviates these issues, and also can provide a more energy efficient and lower area implementation.

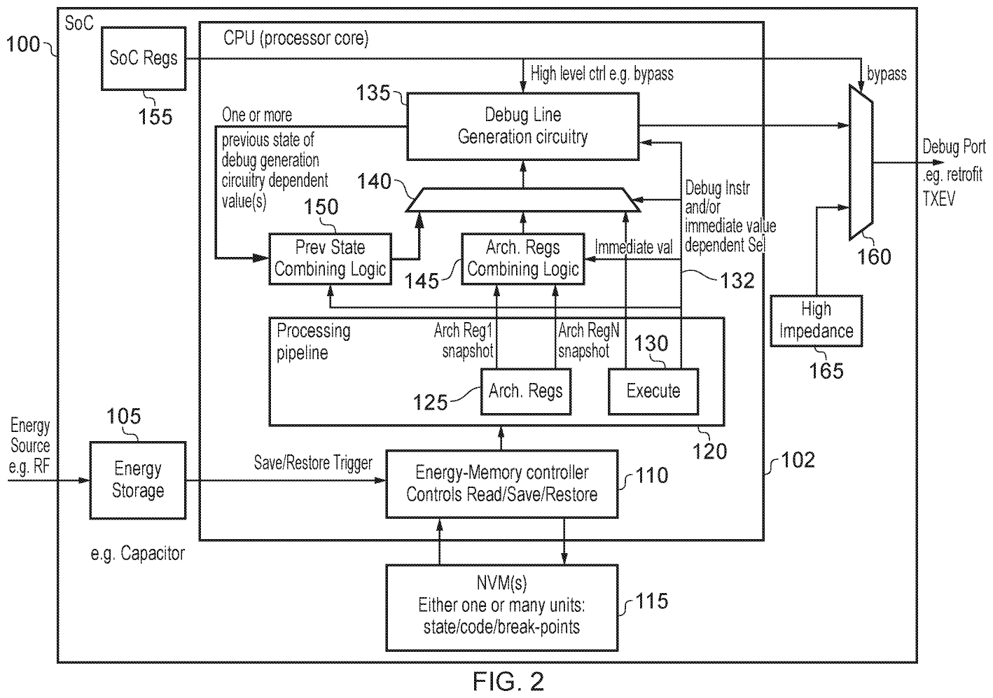

FIG. 2 is a block diagram illustrating components provided with an apparatus in accordance with one example implementation. Here, the apparatus 100 takes the form of a SoC that includes a central processing unit (CPU) 102 that may also be referred to herein as a processor core. Energy is received from an energy source, and in this example implementation takes the form of a radio frequency (RF) signal received by the SoC 100, which results in energy being stored within the energy storage device 105, which may for example take the form of a capacitor. The energy memory controller 110 monitors the level of energy stored within the energy storage 105, in particular to determine whether the energy level exceeds the go/restore level 45, or has dropped to the save/stop level 50 discussed earlier with reference to FIG. 1. By monitoring this information, the energy memory controller 110 can determine when it is appropriate to halt the operations of the processing pipeline 120 and store a snapshot of the current state within the non-volatile memory device(s) 115, and also when there is sufficient energy to warrant restarting the processing pipeline 120, in which case that snapshot of state can be restored from the non-volatile memory device(s) 115.

The processing pipeline 120 will typically consistent of a number of pipeline stages, including an execute stage 130 that is arranged to execute instructions fetched from memory. The data manipulated by the processing pipeline when executing the instructions can be stored in one or more architectural registers 125.

In accordance with the techniques described herein, the sequence of instructions to be executed by the processing circuitry includes a plurality of debug information triggering instructions. Such instructions can be added throughout the code that needs to be executed, so as to periodically cause the processing pipeline to execute a debug information triggering instruction.

When the processing pipeline executes such a debug information triggering instruction, this causes a trigger signal to be generated over path 132 to debug line generation circuitry 135. This trigger signal causes the debug line generation circuitry 135 to generate a debug information signal whose form is dependent on a control parameter specified by the debug information triggering instruction that has been executed. That control parameter may be passed to the debug line generation circuitry 135 and/or can be used to influence information forwarded via the multiplexer 140 to the debug line generation circuitry 135, where that information is then used by the debug line generation circuitry to generate the debug information signal in a form that is dependent on the control parameter.

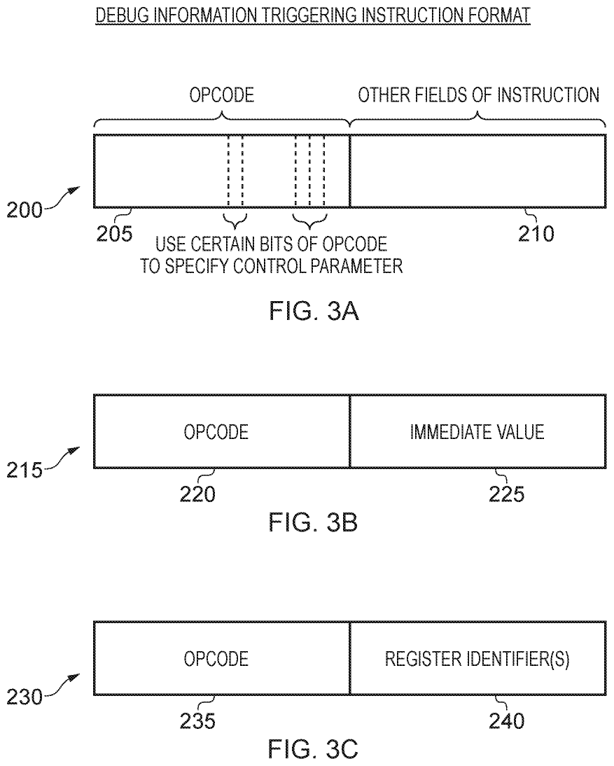

The control parameter information can be specified in a number of different ways within the debug information triggering instruction, and various example formats are shown, by way of non-limiting examples, in FIGS. 3A to 3C. In the example of FIG. 3A, the debug information triggering instruction 200 may have an opcode portion 205 and one or more other fields 210 to provide other information concerning the instruction. The other fields could identify immediate values, register identifiers, condition code information, etc. In the example shown in FIG. 3A, the control parameter is actually specified by certain bits of the opcode. Hence, in this example there are actually a number of different variants of debug information triggering instruction, with those variants being identified by the relevant bits in the opcode.

These opcode bits may be used directly as a control parameter to influence the generation of the debug information signal by the debug line generation circuitry, for example to influence the number of pulses contained within that signal, the duration of the signal, etc. Alternatively, those different variants could be used to specify different ways in which the control information used by the debug line generation circuitry is provided. For example, one variant of the debug information triggering instruction may identify that the debug line generation circuitry should receive an immediate value encoded into one of the other fields 210 of the instruction, via the multiplexer 140, and then use that immediate value to control the form of debug information signal generated. The immediate value could for example directly encode the required information, for example the length of a pulse width to be generated, or the number of pulses to be generated, or can be used as an index into a table defining the signal to be generated (for example by identifying within the table an entry specifying a pulse pattern to be generated as the debug information signal).

As another example, one of the variants of debut information triggering instruction, as determined from an analysis of the relevant opcode bits within the field 205, may identify that the debug line generation circuitry 135 should receive a snapshot of the state of one or more architectural registers, and use that information to control the form of the debug information signal generated. As shown in FIG. 2, this can be achieved by using the architectural register combining logic 145 to take a snapshot of the relevant register or registers from the architectural registers 125, in dependence on the control signal received from the execute stage 130, with the multiplexer 140 then providing that information to the debug line generation circuitry 135.

As a yet further example, one or more variants of the debug information triggering instruction, as determined by the relevant opcode bits, may identify that the debug line generation circuitry 135 should generate the debug information signal based on a state of one or more versions of the debug information signal previously generated. For this purpose, previous state combining logic 150 may be provided that takes a control signal from the execute stage, and generates the necessary information for routing via the multiplexer 140 to the debug line generation circuitry 135. By way of a simple specific example, the previous state combining logic 150 could be arranged to generate an inverse version of the previously generated debug information signal output by the debug line generation circuitry.

From the above discussion, it will be appreciated that by allowing a number of bits of the opcode to specify the control parameter, and in essence provide a number of different variants of the debug information triggering instruction, there is a great deal of flexibility as to how the control information to be used by the debug line generation circuitry is generated in dependence on the control parameter, and hence a great deal of flexibility in the form of debug information signals that can be generated.

However, it should be noted that there is no need for the debug information triggering instruction format to have multiple different opcode variants.

FIG. 3B shows an example where the debug information triggering instruction 215 has opcode portion 220 that identifies the instruction as being a debug information triggering instruction, and an additional field 225 that provides an immediate value. This immediate value can be output by the execute stage and routed via the multiplexer 140 to the debug line generation circuitry 135 for use in generating the debug information signal. Similarly, FIG. 3C illustrates a debug information triggering instruction 230 whose opcode 235 identifies the instruction as being a debug information triggering instruction, and where the additional field 240 provides an identifier for one or more registers within the architectural registers 125. That register identifier information can then be used to instruct the architectural register combining logic 145 as to the snapshot of state that is required to be obtained from the architectural registers, and then forwarded via the multiplexer 140 to the debug line generation circuitry 135.

Returning to FIG. 2, it will hence be appreciated that each time a debug information triggering instruction is executed within the processing pipeline 120, the debug line generation circuitry 135 can be triggered to generate a debug information signal whose form is dependent on a control parameter specified by the executed debug information triggering instruction. In one example implementation, the duration of the debug information signal can be varied in dependence on the control parameter, as can the number and form of the pulses sent within that duration of time, but it should be noted that the duration of time for which the debug information signal is generated is entirely decoupled from the actual time taken to execute the debug information triggering instruction within the processing pipeline. Hence, the actual form of debug information signal generated does not constrain the execution time within the processing pipeline of each debug information triggering instruction.

In one example implementation, each debug information triggering instruction is arranged to be executed within the processing pipeline in a manner that prevents the execution of that debug information triggering instruction causing any subsequent instructions in a sequence of instructions being executed by the processing pipeline to stall. In one particular example, the debug information triggering instruction passes through the pipeline in much the same way as a no operation (NOP) instruction, in terms of its lack of effect on the timing of processing of subsequent instructions. However, when the debug information triggering instruction reaches the execute stage, it does cause the generation of the earlier-mentioned trigger to the debug line generation circuitry 135 along with the provision of the relevant control parameter information to enable the debug line generation circuitry to generate a form of debug information signal that is dependent on that control parameter. The generation of the debug information signal is then performed asynchronously with respect to the timing of execution of the debug information triggering instruction. In one particular example, each debug information triggering instruction is executed in a single cycle within the execute stage 130. In contrast, the corresponding debug information signals generated may be observed over multiple clock cycles via the debug port of the apparatus 100.

If desired, the functionality of the debug line generation circuitry 135 can be selectively enabled and disabled, as illustrated by way of example with reference to the components 155, 160, 165 shown in FIG. 2. In particular, one or more SoC registers 155 can be used to identify whether the above described debug functionality is enabled or disabled. When enabled, the debug line generation circuitry 135 operates as discussed earlier, and the multiplexer 160 is arranged to output to the debug port the signals generated by the debug line generation circuitry. However, when the functionality is disabled, the debug line generation circuitry 135 is arranged not to generate debug information signals, and the multiplexer 160 outputs from the debug port a fixed signal generated by the high impedance circuit 165. In another example implementation, the presence or absence of the enable signal could be used to control whether the processing pipeline 120 generates a trigger signal to the debug line generation circuitry 135, along with appropriate control signals to the components 140, 145, 150, or whether those signals are suppressed by the processing pipeline.

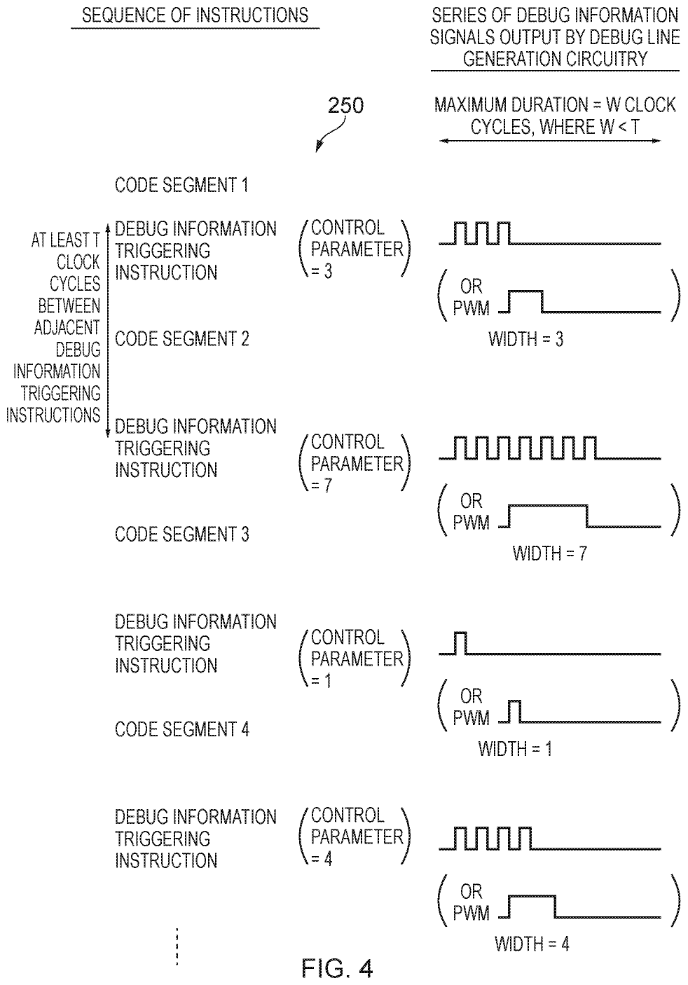

FIG. 4 schematically illustrates how the code being executed by the processing pipeline may be formed of multiple segments that are separated by instances of the debug information triggering instruction. As shown in FIG. 4, by varying the control parameter associated with each instance of the debug information triggering instruction, this can enable the form of debug information signal generated by each instance of the debug information triggering instruction to differ, and hence allow the debugger to track progress of the execution of the code by monitoring the debug information signals generated from the debug port.

In this particular example, it is assumed that the control parameter directly encodes information about either the number of pulses to generate, or the width of a single pulse to be generated, when forming the debug information signal. Hence, between code segment 1 and code segment 2 within the code 250 illustrated in FIG. 4, execution of the intervening debug information triggering instruction may cause a debug information signal with three pulses to be generated, or for a debug information signal with a single pulse of a three clock cycle width to be generated. FIG. 4 also shows the corresponding debug information signals that can be generated for each subsequent occurrence of the debug information triggering instruction.

Whilst in principle each instance of the debug information triggering instruction could have a unique control parameter value, it is to be noted that this is not necessary, since the debugger can analyse progress with reference not only to a single output debug information signal, but instead with reference to a series of debug information signals generated as execution to the code progresses. Hence, certain instances of the debug information trigger instruction could cause the same form of debug information signal to be generated, but with the debugger still being able to determine progress by virtue of being able to evaluate the series of debug information signals received.

As shown in FIG. 4, since the duration of a debug information signal can vary dependent on the control parameter information provided, in one example implementation a maximum duration of W clock cycles is provided as a constraint, and furthermore the debug information triggering instructions are distributed through the code 250 in a manner than can ensure that at least T clock cycles take place between execution of adjacent debug information triggering instructions within the code 250, where T is greater than W. This hence ensures that there is no prospect of overlap between the discrete debug information signals generated as a result of execution of each instance of the debug information triggering instruction.

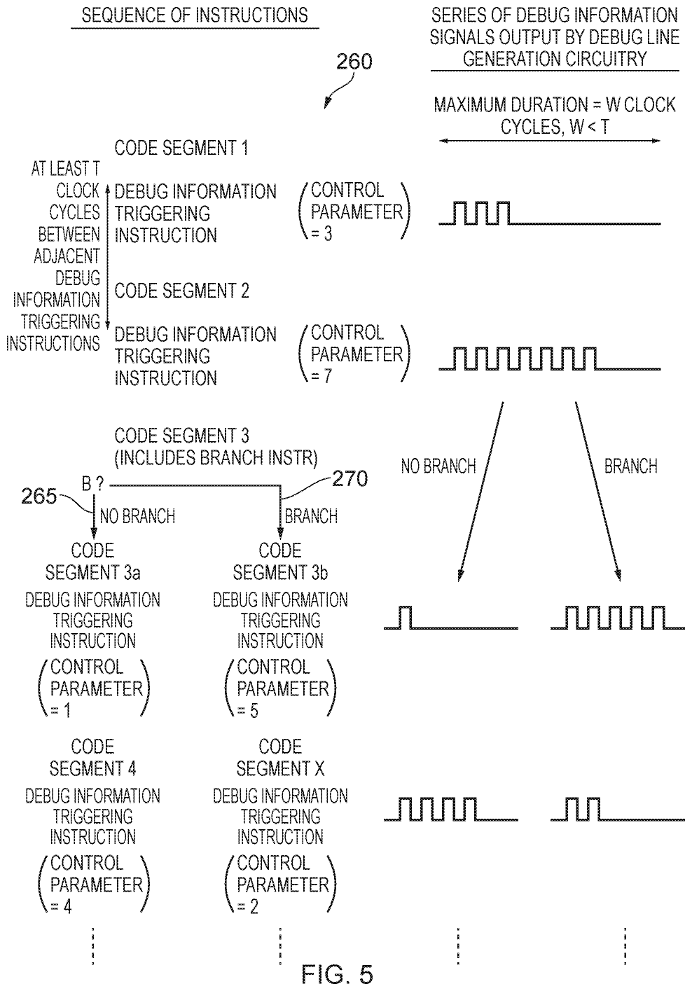

It should be noted that the above described mechanism not only allows the debugger to track the sequential progress through code, but can also allow the debugger to assess paths taken through the code, for example dependent on whether branch instructions result in a taken branch or a not taken branch. This is illustrated schematically in FIG. 5, where the code 260 again consists of a number of code segments that are separated by debug information triggering instructions having associated control parameters, but in this example it is assumed that code segment 3 includes a branch instruction.

As can be seen from FIG. 5, in the event of no branch being taken as indicated by the path 265, progress proceeds to code segment 3A and subsequently to code segment 4, and as a result the debug information triggering instructions shown on the left hand side of FIG. 5 are executed resulting in the generation of debug information signals whose form is dependent on their control parameters. In this example, it is assumed that the control parameter directly identifies the number of pulses, and accordingly it can be seen that in the event of a no branch the debugger receives a first debug information signal with three pulses, a second debug information signal with seven pulses, a third debug information signal with one pulse, and a fourth debug information signal with four pulses.

Conversely, if the branch is taken, as indicated by the path 270, then it will be seen that different code segments are executed and accordingly different debug information triggering instructions, having different control parameters, also are executed. Hence, if the branch is taken, the debugger will see debug information signals having three pulses, seven pulses, five pulses and two pulses, respectively. As a result, it will be appreciated that the debugger can evaluate the path taken through the code in addition to evaluating the current location within the code that execution has reached when any particular debug information signal is generated.

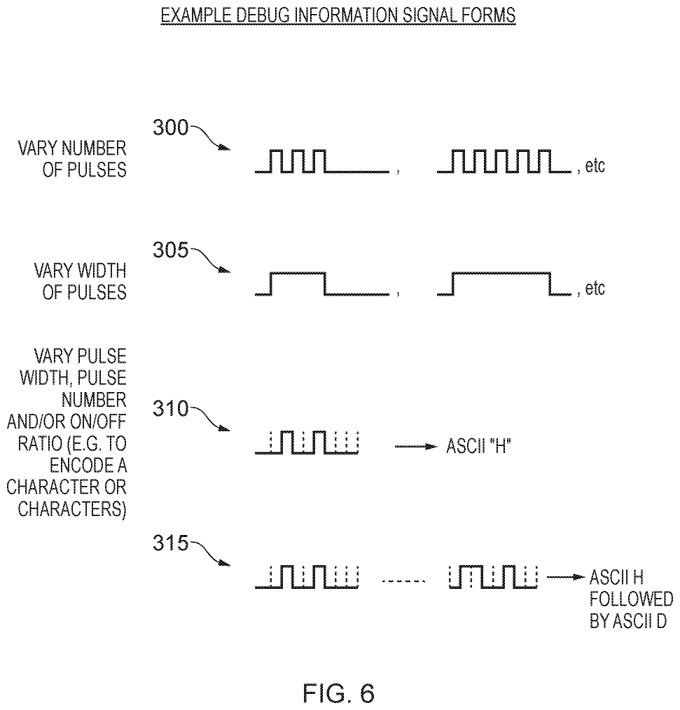

There are a variety of different forms of debug information signal that can be generated using the techniques described herein, and indeed it will be appreciated from the earlier discussions that the control parameters can cause a wide variety of different information to be made available to the debug line generation circuitry 135 in order to control the form of debug information generated. By way of non-limiting example, various possible options are shown in FIG. 6. As shown by the forms 300, the number of pulses may be varied in dependence on the control parameter. As shown by the forms 305, instead the width of pulse generated could be varied. Alternatively, a combination of both the number of pulses and the widths of individual pulses can be varied, and indeed the on/off ratio between pulses could also be varied. By such techniques, as shown by the form 310, a particular character value could be output as the debug information signal, such as the ascii character H. Alternatively, multiple characters could be output to form a single debug information signal generated in response to execution of a debug information triggering instruction, as indicated by the form 315. It should also be noted that the high/low state of the pulses could also be altered in dependence on the control parameter information, and hence it can be varied whether a pulse is asserted high or is asserted low.

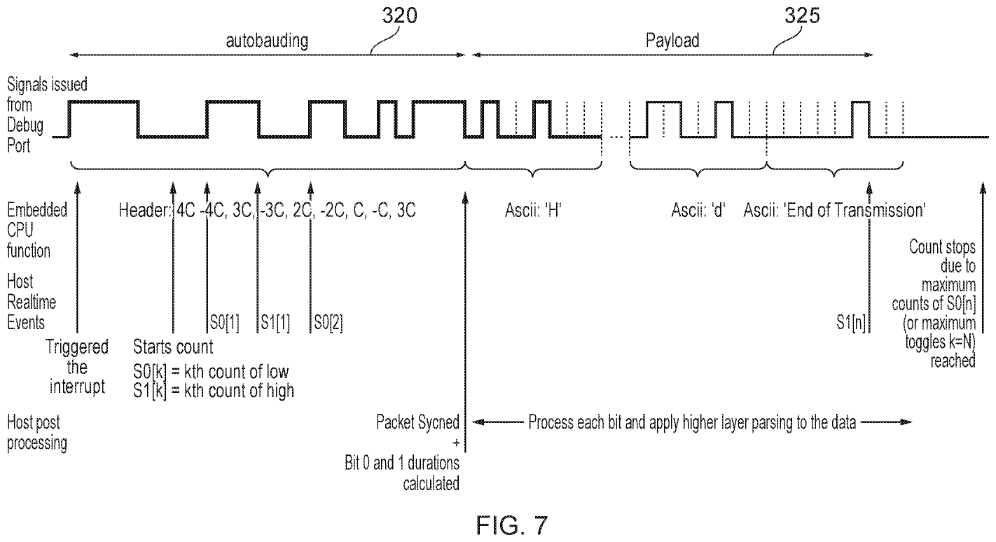

If desired, an autobauding functionality could be added via the debug port in order to periodically allow the receiver, for example the debugger apparatus, to calibrate the clock frequency C, as illustrated in FIG. 7. Once the autobauding signals 320 have been used to calibrate the clock frequency, then the subsequent payload 325 can be interpreted appropriately. In this example, the payload consists of a number of ascii characters, and as discussed earlier each occurrence of a debug information triggering instruction may cause a particular ascii character to be generated, or multiple ascii characters could be generated in response to one debug information triggering instruction. Such a technique can be used, for example, to implement a low overhead printf( ) function.

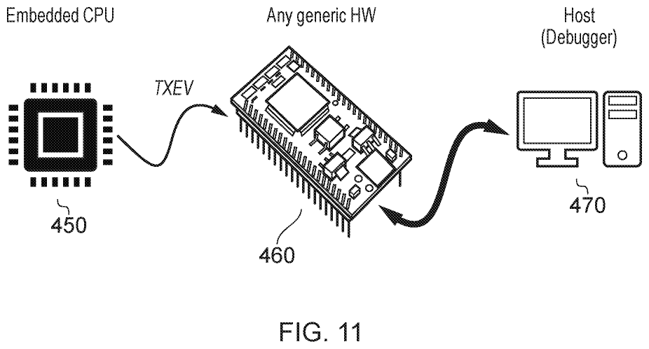

As will be discussed later with reference to FIG. 11, if desired, an intervening component may exist between the apparatus outputting the signals from the debug port, and a debugger used to perform debug operations based on that information. This intervening component could for example be used to perform the autobauding analysis, and to process each received bit in the payload in order to apply a higher level parsing to the data before outputting that processed data to the debugger.

Typically, the autobauding functionality would be performed relatively infrequently. If desired, for example in situations where there is significant noise on the communication channel to the debugger, then between such autobauding events a calibration trigger could be used to cause a sequence known to the debugger apparatus to be output from the debug port of the apparatus, for use by the debugger apparatus to calibrate for noise on that communication channel. This could be useful for example in over the air communication. Whilst any suitable sequence could be used, in one example implementation a random sequence could be used which additionally gives the receiver the ability to perform an alignment/synchronisation process, thereby giving the receiver the ability to monitor the progress of computations under noisy conditions, including potentially completing loss of packets, due to better correlation properties.

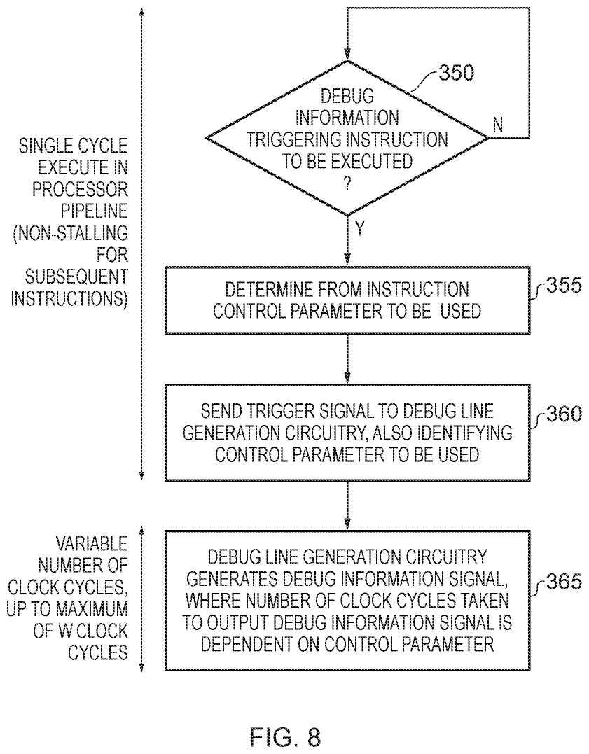

FIG. 8 is a flow diagram illustrating the handling of debug information triggering instructions in accordance with the techniques described herein. At step 350, it is determined within the processing pipeline whether there is a debug information triggering instruction to be executed, and when there is then at step 355 the execute stage of the pipeline determines from the debug information trigger instruction the control parameter to be used. At step 360, a trigger signal is then sent to the debug line generation circuitry, also identifying the control parameter to be used. As discussed earlier with reference to FIG. 2, this may also involve sending various control signals to the components 140, 145, 150 to ensure that the debug line generation circuitry 135 is provided with all of the control parameter dependent information it needs in order to generate a suitable debug information signal. As shown in FIG. 8, steps 350, 355, 360 are performed in a single cycle within the execute stage of the processor pipeline, and as such execution of the debug information triggering instruction does not stall subsequent instructions.

Once the debug line generation circuitry has received the trigger, then at step 365 it generates a debug information signal, where the number of clock cycles taken to output the debug information signal is dependent on the control parameter. As noted in FIG. 8, the generation of the debug information signal can hence take a variable number of clock cycles, up to a maximum of W clock cycles, but this activity occurs asynchronously to the execution of the corresponding debug information triggering instruction within the pipeline, and hence has no influence on the progression of instructions through the processor pipeline.

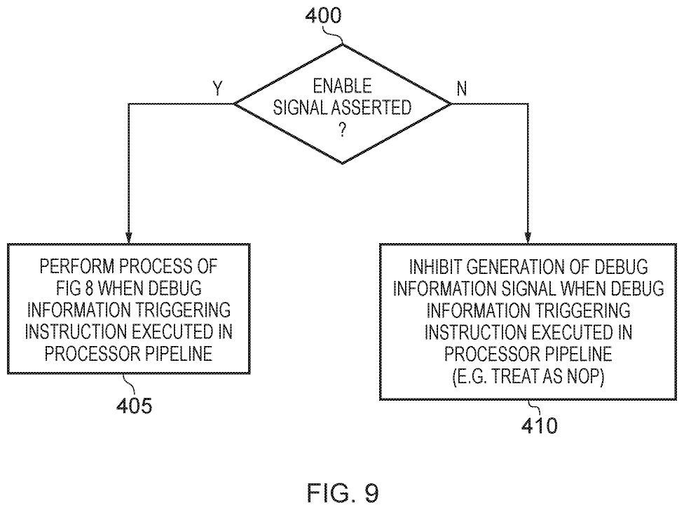

FIG. 9 is a flow diagram schematically illustrating how an enable signal may be used to selectively turn the above described functionality on and off. At step 400, it is determined whether an enable signal is asserted, and if so then at step 405 the process of FIG. 8 is performed when a debug information triggering instruction is executed in the processor pipeline. However, if the enable signal is not asserted, then at step 410 generation of a debug information signal can be inhibited when the debug information trigger instruction is executed in the processor pipeline. This can be achieved by either suppressing generation of a trigger signal from the processor pipeline to the debug line generation circuitry, or by inhibiting operation of the debug line generation circuitry and/or outputting a constant signal from the debug port. In one example implementation, the debug information triggering instruction is treated as a NOP instruction when the enable signal is not asserted.

There are a number of reasons why it might be desirable to be able to selectively disable the above-described debug functionality. For example, it may be that the apparatus in which the software is being executed has other pre-existing debug functionality in place, and in some instances it may be desired to use that pre-existing debug functionality, in which case it may be desirable to turn the above described debug functionality off.

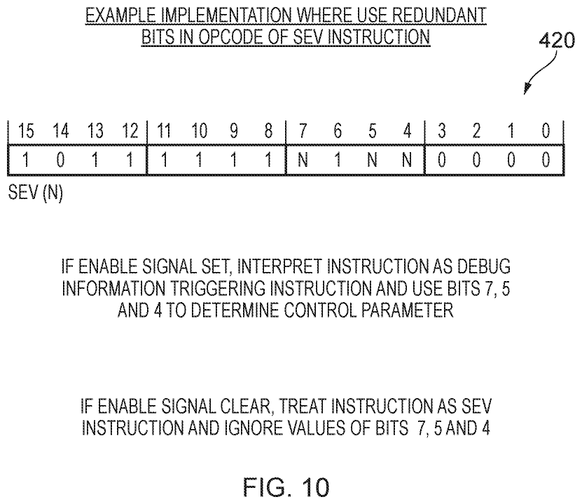

In one example implementation, the debug information triggering instruction can be provided with its own dedicated opcode, or opcodes if more than one variant of the debug information triggering instruction is supported. However, in an alternative implementation, if desired, such debug information triggering instructions can be supported by using redundant encoding space within an existing instruction. A specific example is shown in FIG. 10, for a send event (SEV) instruction 420. In accordance with such an instruction, bits 4, 5 and 7 are typically at a logic zero value, but in one example implementation those bits can be selectively modified so that at least one of them has a logic 1 value. If one or more of bits 4, 5 and 7 are set to a logic 1 value, then the instruction can be interpreted as a debug information triggering instruction rather than an SEV instruction.

In one particular example implementation, the value collectively provided by bits 7, 5 and 4 can be used to identify the control parameter of the debug information triggering instruction, hence for example identifying the number of pulses to be output in the corresponding debug information signal, or the pulse width to be used. For systems supporting use of SEV instructions, an output pin (referred to as the TXEV pin) will typically already be provided that is used to issue the send event signal. However, when any of bits 7, 5 and 4 are set, then the above-described debug information signal functionality can be triggered to generate over the same output pin the desired debug information signal.

In such an implementation, the earlier-mentioned enable signal can, if desired, be used to turn the debug information signal functionality on or off. For example, if the enable signal is set, then the instruction can be interpreted as the debug information triggering instruction, and bits 7, 5 and 4 can be used to determine a control parameter. Conversely, if the enable signal is clear, then the instruction can be treated as an SEV instruction, and the value of bits 7, 5 and 4 can be ignored.

In one example implementation, the signals output from the apparatus shown in FIG. 2 via the debug port could be provided directly to a debugger. However, as indicated in FIG. 11, if desired those signals could first be passed to an intervening hardware entity 460, which could perform some initial processing on the signals received in order to generate a richer set of information to pass to the debugger. For example, such a hardware component 460 could have a lookup table encoded therein, with the received debug information signals being used to perform a lookup within that table in order to generate information to be passed onto the debugger. Such hardware 460 could for example take the form of a field programmable gate array (FPGA) or an mbed component.

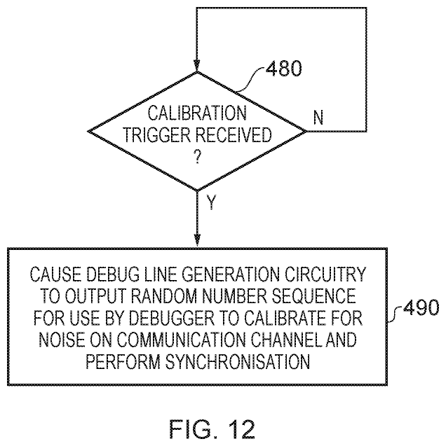

FIG. 12 is a flow diagram illustrating how a calibration trigger can be used to generate information from the debug port that can be used to calibrate for noise. At step 480, it is determined whether a calibration trigger has been received. When the calibration trigger is received, then at step 490 the debug line generation circuitry is caused to output a random number sequence, or a small portion thereof, for use by the debugger to calibrate for noise on the communication channel, and to perform synchronisation. As discussed earlier, this can allow for calibration in the presence of noisy communication paths, and hence improve the accuracy of the debugging operations.

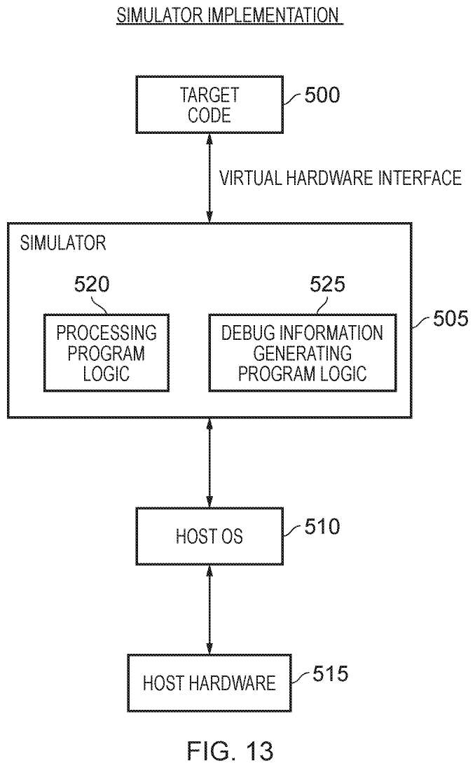

FIG. 13 illustrates a simulator implementation that may be used. Whilst the earlier described examples implement the present technique in terms of apparatus and methods for operating specific processing hardware supporting the techniques concerned, it is also possible to provide an instruction execution environment in accordance with the examples described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically a simulator implementation may run on a host processor 515, optionally running a host operating system 510, supporting the simulator program 505. In some arrangements there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990, USENIX Conference, Pages 53 to 63.

To the extent that examples have previously been described with reference to particular hardware constructs or features, in a simulated implementation equivalent functionality may be provided by suitable software constructs or features. For example, particular circuitry may be provided in a simulated implementation as computer program logic. Similarly, memory hardware, such as register or cache, may be provided in a simulated implementation as a software data structure. Also, the physical address space used to access memory in the hardware apparatus could be emulated as a simulated address space which is mapped on to the virtual address space used by the host operating system 510 by the simulator 505. In arrangements where one or more of the hardware elements referenced in the previously described examples are present on the host hardware (for example host processor 515), some simulated implementations may make use of the host hardware, where suitable.

The simulator program 505 may be stored on a computer readable storage medium (which may be a non-transitory medium), and provides a virtual hardware interface (instruction execution environment) to the target code 500 (which may include applications, operating systems and a hypervisor) which is the same as the hardware interface of the hardware architecture being modelled by the simulator program 505. Thus, the program instructions of the target code 500 may be executed from within the instruction execution environment using the simulator program 505, so that a host computer 515 which does not actually have the hardware features of the apparatus discussed above can emulate those features. The simulator program may include processing program logic 520 to emulate the behaviour of the processing pipeline 120, and debug information generating program logic 525 to emulate the behaviour of the debug line generation circuitry 135. Hence, the techniques described herein for supporting the execution of debug information triggering instructions can in the example of FIG. 13 be implemented in software by the simulator program 505.

In accordance with the techniques described herein, it is possible to generate an externally observable low-latency signal which is actuated for at least one processor clock cycle and directly by the processor, without the need for intervening buffer or peripheral components, as the result of a single-cycle execute instruction. The control parameter specified by the instruction can be used to influence the form of debug information signal generated, and thereby allow the debugger to evaluate where in the program flow the processor was at the time the debug information triggering instruction was executed.

As mentioned earlier, the techniques described herein can be useful in many different implementations. In addition to the battery-less processor example given earlier, it may for example be useful in low cost printed electronics implementations where memory is less reliable. For instance, such a process could be used to check that one or more instructions could be fetched and executed, for example by adding the debug information triggering instructions before and after the instructions of interest. Further, in low cost emerging non-volatile memory technology, where yield can be relatively poor, the use of these techniques could be used to check the reliable reading of data from and/or writing of data to memory locations.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. An apparatus comprising:
processing circuitry to execute a sequence of instructions that includes a plurality of debug information triggering instructions; and
debug information generating circuitry for coupling to a debug port;
wherein:
the processing circuitry is arranged, on executing a given debug information triggering instruction in the plurality of debug information triggering instructions, to trigger the debug information generating circuitry to generate a debug information signal whose form is dependent on a control parameter specified by the given debug information triggering instruction, and to output the generated debug information signal from the debug port for reference by a debugger apparatus; and
the control parameter is such that the form of the debug information signal enables the debugger apparatus to determine a state of the processing circuitry when the given debug information triggering instruction was executed.

2. An apparatus as claimed in claim 1, wherein one or more of the debug information triggering instructions in the plurality of debug information triggering instructions has a control parameter that differs to the control parameter specified by one or more other debug information triggering instructions in the plurality of debug information triggering instructions, such that the form of the debug information signal generated by the debug information generating circuitry is dependent on which debug information triggering instruction is executed.

3. An apparatus as claimed in claim 2, wherein the debug information generating circuitry is arranged to generate a series of debug information signals in response to a series of debug information triggering instructions in the plurality being executed, to enable the debugger apparatus to determine the state of the processing circuitry when the given debug information triggering instruction was executed based on both the form of the debug information signal generated as a result of executing the given debug information triggering instruction and the form of one or more previously generated debug information signals.

4. An apparatus as claimed in claim 1, wherein the state of the processing circuitry is an indication of which instructions within the sequence of instructions had been executed by the processing circuitry at the time the given debug information triggering instruction was executed.

5. An apparatus as claimed in claim 1, wherein the debug information generating circuitry is arranged to determine a duration of time for which the debug information signal is output from the debug port in dependence on the control parameter specified by the given debug information triggering instruction.

6. An apparatus as claimed in claim 5, wherein the debug information generating circuitry is arranged to control, in dependence on the control parameter, at least one of a number of pulses, a duration of individual pulses and a time gap between pulses when generating the form of the debug information signal output during the determined duration of time.

7. An apparatus as claimed in claim 5, wherein the determined duration of a time is one or more clock cycles, where the number of clock cycles is dependent on the control parameter.

8. An apparatus as claimed in claim 5, wherein a time taken by the processing circuitry to execute the given debug information triggering instruction is independent of the determined duration of time over which the debug information signal is output from the debug port.

9. An apparatus as claimed in claim 5, wherein:
the debug information triggering instructions are separated from each other within the sequence of instructions by an amount that ensures that at least T clock cycles pass between execution of adjacent debug information triggering instructions;
and the determined duration of time is constrained to have a maximum value of W clock cycles, where W is less than T in order to ensure a separation between each debug information signal output from the debug port.

10. An apparatus as claimed in claim 1, wherein the processing circuitry comprises a plurality of pipeline stages and is arranged to process each debug information triggering instruction in a manner that prevents the execution of that debug information triggering instruction causing a subsequent instruction in the sequence to stall within one or more pipeline stages of the processing circuitry.

11. An apparatus as claimed in claim 10, wherein the plurality of pipeline stages includes a given pipeline stage where the debug information triggering instruction becomes non-speculative, and each debug information triggering instruction is executed in a single clock cycle within the given pipeline stage.

12. An apparatus as claimed in claim 1, wherein the control parameter is specified as an immediate value within the given debug information triggering instruction.

13. An apparatus as claimed in claim 1, wherein the control parameter is specified within an opcode portion of the given debug information triggering instruction.

14. An apparatus as claimed in claim 1, wherein the control parameter identifies one or more registers, and the debug information generating circuitry is arranged to reference current values of those one or more registers when determining the form of the debug information signal to be generated.

15. An apparatus as claimed in claim 1, wherein the control parameter causes the debug information generating circuitry to derive the form of the debug information signal by modifying the form of one or more previously issued debug information signals.

16. An apparatus as claimed in claim 1, further comprising:
an input to receive an enable signal;
wherein the debug information generating circuitry is arranged to inhibit generation of the debug information signal in the absence of the enable signal being asserted.

17. (canceled)

18. (canceled)

19. An apparatus as claimed in claim 1, wherein the apparatus is arranged to receive power from an energy harvesting source, and further comprises:
a controller to save state of the apparatus to non-volatile memory, and restore state from the non-volatile memory, in dependence on an energy state of the energy harvesting source.

20. An apparatus as claimed in claim 1 wherein the debug information generating circuitry is arranged, in response to a calibration trigger, to output a sequence known to the debugger apparatus, for use by the debugger apparatus to calibrate for noise on a communication channel between the debug port and the debugger apparatus.

21. A method of generating debug information, comprising:
executing within processing circuitry a sequence of instructions that includes a plurality of debug information triggering instructions;
coupling debug information generating circuitry to a debug port;
on executing within the processing circuitry a given debug information triggering instruction in the plurality of debug information triggering instructions, triggering the debug information generating circuitry to generate a debug information signal whose form is dependent on a control parameter specified by the given debug information triggering instruction; and
outputting the generated debug information signal from the debug port for reference by a debugger apparatus;
wherein the control parameter is such that the form of the debug information signal enables the debugger apparatus to determine a state of the processing circuitry when the given debug information triggering instruction was executed.

22. A computer program for controlling a host data processing apparatus to provide an instruction execution environment, comprising:
processing program logic to execute a sequence of instructions that includes a plurality of debug information triggering instructions; and
debug information generating program logic for coupling to a debug port;
wherein:
the processing program logic is arranged, on executing a given debug information triggering instruction in the plurality of debug information triggering instructions, to trigger the debug information generating program logic to generate a debug information signal whose form is dependent on a control parameter specified by the given debug information triggering instruction, and to output the generated debug information signal from the debug port for reference by a debugger apparatus; and
the control parameter is such that the form of the debug information signal enables the debugger apparatus to determine a state of the processing program logic when the given debug information triggering instruction was executed.
